(19) United States
(12) Patent Application Publication
(10) Pub. No.: US 2007/0254980 A1
(43) Pub. Date: Nov. 1, 2007

(54) Radiation resistant cross linked polymer compositions and radiation resistant polymer products

(75) Inventors: Sadayoshi Nakatsukasa, Asakuti-gun (JP); Takesi Tabasaki, Fukuyama-shi (JP); Joichi Kusano, Naka-gun (JP); Fumihiro Masukawa, Naka-gun (JP)

Correspondence Address: OLIFF & BERRIDGE, PLC, P.O. BOX 19928, ALEXANDRIA, VA, 22320, US

(73) Assignee: HAYAKAWA RUBBER CO., LTD/, Fukuyama-shi (JP)

(21) Appl. No.: 11/822,273

(22) Filed: Jul. 3, 2007

Related U.S. Application Data
(62) Division of application No. 10/893,497, filed on Jul. 19, 2004.

(30) Foreign Application Priority Data
Jul. 31, 2003 (JP) 2003-283989

(51) Int. Cl. G21F 1/10

(52) U.S. Cl. 523/136

(57) ABSTRACT

A radiation resistant cross linked polymer composition for maintaining appropriate physical properties after it is exposed to radiation comprising polymer components and a softening agent in an amount of 3 weight parts or more with respect to 100 weight parts of the polymer components. The polymer components comprise a first polymer component of one or more polymer selected from the group consisting of butyl rubber, polyisobutylene rubber, epichlorohydrin rubber and polypropylene in a content of 3 to 70 weight parts and a second polymer component of one or more polymer selected from the group consisting of chloroprene rubber and a polymer containing an ethylene unit as a main component in a content of 97 to 30 weight parts.

This is a Division of application Ser. No. 10/893,497 filed Jul. 19, 2004. The entire disclosure of the prior application is hereby incorporated by reference in its entirety.

### BACKGROUND

1. Field of the Invention

The present invention relates to a radiation resistant cross-linked polymer composition suitable for polymer products used in various kinds of cables, packings, water cut-off materials, etc., in nuclear related facilities such as nuclear power plants, facilities for the reprocessing of used nuclear fuel, and proton accelerators.

2. Related Art Statement

Various kinds of polymer compositions suitable for use in nuclear power facilities have been proposed. Such known polymer compositions are described in, for example, Japanese Patent No. 2893360B, Japanese Patent Examined Publication No. 8-869, Japanese Patent Publication 8-151490A, and an article in “Hitachi Cable”, No. 9 (1990-1), pages 77 to 82 titled “Development of an ultra radiation resistant cable.”

### SUMMARY

In recent years, there has been a demand for compositions with further improved radiation resistance. As a specific radiation dope, it is required that a polymer maintain appropriate hardness and bending properties after the polymer is exposed to radiation levels of, for example, about 5 MGy to 10 MGy. When a polymer composition is subjected to such high radiation levels, the polymer composition is deteriorated due to hardening or softening. Thus, it has been almost impossible to obtain polymer compositions that maintain their general properties after exposure to radiation.

An object of the present invention is to provide a radiation resistant polymer composition for maintaining appropriate hardness and bending properties after it is exposed to radiation.

The present invention provides a radiation resistant cross-linked polymer composition comprising polymer components and a softening agent in an amount of 3 weight parts or more with respect to 100 weight parts of the polymer components. The polymer components comprise a first polymer component of one or more polymers selected from the group consisting of butyl rubber, polyisobutylene rubber, epichlorohydrin rubber, and polypropylene in a content of 3 to 70 weight parts and a second polymer component of one or more polymer selected from the group consisting of chloroprene rubber and a polymer containing an ethylene unit as a main component in a content of 97 to 30 weight parts.

Embodiments of the radiation resistant cross-linked polymer composition according to the present invention, maintain appropriate hardness and physical properties after exposure to radiation. The radiation resistant cross-linked polymer composition may be applied to polymer products requiring radiation resistance such as those for nuclear related facilities. It is thereby possible to considerably improve hardness and bending properties after exposure to radiation compared with those products made of compositions previously reported. The present invention is thus very useful in a field of engineering.

Embodiments of the radiation resistant cross-linked polymer composition according to the present invention will be described further in detail below.

When a polymer composition is used under circumstances where radiation exposure exists, the polymer composition is normally exposed to a low dose of radiation over a long time period. Various polymers are thereby deteriorated in their performances and properties due to the exposure to radiation. As a polymer is exposed to radiation, the cross-linking and fragmentation of polymer chains occur at the same time. A polymer may be divided into two categories: cross-linking and decomposition types, of which the cross-linking and fragmentation are dominant during exposure. The cross-linking type polymers include natural rubber, chloroprene rubber, ethylene-propylene rubber, isoprene rubber, styrene-butadiene rubber, butadiene rubber, acrylonitrile-butadiene rubber, polyethylene, or the like. The decomposition type polymers include polyisobutylene rubber, butyl rubber, epichlorohydrin rubber, and polypropylene. The cross-linking type polymers become hard and brittle due to a reduction of elongation and an increase of modulus. The decomposition type polymer becomes brittle due to reduction of tensile strength, elongation and hardness.

The solution for preventing deterioration due to exposure to radiation provided by the present invention is based on a novel concept substantially different from known solutions in the art. Protectants have been added into a radiation resistant polymer so that the species, combination and amounts of the protectants are adjusted. This method is expected to be useful to some degree against a low dose of radiation. This method is, however, ineffective against a high dose of radiation. Specifically, it has been recently reported that some polymers with specific properties are superior to prior compositions in the art. For example, when such recently reported polymer compositions applying the above method may have a breaking elongation at break of 400 percent or higher, the breaking elongation is reduced to about 20 percent after it is exposed to radiation of 10 MGy. When the breaking elongation is considerably reduced as such, however, bending properties, or the like, are not adequate.

The inventors, through diligent study and testing have discovered the following novel composition. That is, known radiation resistant polymers previously reported include ethylene-propylene polymer and chloroprene rubber. Such radiation resistant polymers are deteriorated in hardness after it is exposed to a high dose of radiation, so that its bending properties are lost. An appropriate amount of softening deterioration type polymer such as isobutylene polymer, epichlorhydrin polymer, or polypropylene polymer is mixed with the above-described hardening deterioration type polymer. It is proved that the deterioration processes due to cross-linking and decomposition of the polymer composition may proceed at the same time, so that apparent changes of properties such as surface hardness can be successfully minimized.

These and other objects, features, and advantages of the invention will be appreciated upon reading the following description of the invention with the understanding that some modifications, variations, and changes of the same could be made by the skilled person in the art.

### DETAILED DESCRIPTION OF EMBODIMENTS

According to the present invention, to 100 weight parts of polymer components, 3 to 70 weight parts of a first polymer component of at least one polymer selected from the group consisting of butyl rubber, polyisobutylene rubber, epichlorohydrin rubber, and polypropylene and 97 to 30 weight parts of a second polymer component of one or more polymer selected from the group consisting of chloroprene rubber and a polymer containing an ethylene unit as a main component are blended.

The polymer composition can be properly and controllably degraded by decomposition by adjusting the total content of the first polymer component to 3 weight parts or more. It is thus possible to prevent increases of surface hardness and modulus, and a reduction of elongation due to cross linkage degradation of the second polymer component. In this case, the total content of the first polymer component may preferably be 3 weight parts or higher and more preferably be 5 weight parts or higher.

The reduction of surface hardness, modulus, and breaking properties of a polymer composition can be prevented by adjusting the total content of the first polymer component to 70 weight parts or lower. In this case, the total content of the first polymer component may preferably be 70 weight parts or lower, and more preferably 40 weight parts or lower.

Many cross-linking type polymers are known other than the above-listed chloroprene and a polymer containing ethylene units as the main component used as the second polymer component according to the present invention. When some cross-linking type polymers not listed are used, properties such as the breaking strength of the polymer composition are considerable. The characteristic properties of the composition according to the present invention cannot be obtained.

The first polymer component is of a polymer selected from the group consisting of butyl rubber, polyisobutylene rubber, epichlorohydrin rubber, and polypropylene, or the mixtures thereof.

Butyl rubber means a copolymer of isoprene and isobutylene. Although various grades of butyl rubbers are produced and commercialized depending on the polymer composition, molecular weight or the like, the polymer composition and molecular weight are not particularly limited.

Polyisobutylene rubber is a polymer substantially composed of isobutylene, and the molecular weight is not particularly limited.

Epichlorhydrin rubber is a product of ring-opening polymerization containing epichlorhydrin, ethylene oxide, and allyl glycidyl ether as the main components.

Polypropylene is a polymer of propylene, and the molecular weight is not particularly limited. Further, a small amount of another monomer, such as ethylene monomer, may be added in the polymerization process.

The second polymer component is composed of a polymer selected from the group consisting of chloroprene rubber and a polymer containing an ethylene unit as a main component, and the mixtures thereof.

In the polymer containing an ethylene unit as the main component, preferably 30 mole percent or higher, more preferably 40 mole percent or higher, of the monomer units are occupied by ethylene units. The polymer includes polyethylene (PE), and denatured polyethylenes such as chlorosulfonated polyethylene rubber (CSM) and chlorinated polyethylene rubber (CM). The polymer may be a two-component copolymer of ethylene and propylene, or a multi-component polymer (such as terpolymer and tetramer) of ethylene, propylene, and the other monomer(s). In the case of an ethylene-propylene series polymer, it is preferred that the propylene units occupy 20 mole percent or more of the total monomer units. Other monomers include ethylidene norbornene, dicyclopentadiene, 1,4-hexadiene, and vinylidene norbornene.

Chlorosulfonated polyethylene may be produced by subjecting polyethylene to a chlorosulfonation reaction. Chlorinated polyethylene may be produced by subjecting polyethylene to a chlorination reaction.

According to the present invention, 3 weight parts or more of a softening agent is added to 100 weight parts of polymer components. It is thereby possible to prevent deterioration of the polymer composition due to hardening. In this case, the total content of the softening agent may be preferably 3 weight parts or more, and more preferably 10 weight parts or more. Although the upper limit of an amount of the softening agent is not particularly defined, it may be 100 weight parts or lower, for example.

The “softening agent” is a general terminology of additives added to the composition for reducing the hardness of a polymer. The “softening agent” includes so-called plasticizers. The softening agent has a high compatibility with a polymer and may penetrate into the molecular chains to function as a kind of a lubricator between the molecular chains.

The softening agent includes a mineral oil softening agent, a vegetable oil softening agent, and a synthetic softening agent (synthetic plasticizer).

The mineral oil softening agent may be categorized into aromatic, naphthene, and paraffin systems. Mineral oil softening agents available are normally composed of a mixture of these three systems.

According to a preferred embodiment, the softening agent is a mineral oil softening agent having an aniline point of 60° C. or lower. An aniline point is used as a scale for indicating the content of aromatic structure such as benzene ring in the softening agent. According to the present invention, it is possible to effectively prevent the deterioration of a polymer composition due to hardening by applying a softening agent having an aniline point of 60° C. or lower (more preferably 45° C. or lower). Such softening agent includes the following.

For example, “AC” and “AH” series supplied by Idemitsu Kosan Co., Ltd., “HA” series supplied by KOBE OIL CHEMICAL INDUSTRIAL Co., Ltd., and products supplied by COSMO OIL CO., LTD., JAPAN ENERGY CORPORATION, Japan Sun Oil Company Ltd., FUJI KOSAN CO., LTD., or the like.

A plasticizer is a general term for synthesized agents among the softening agents. The kind of the plasticizer is not limited, and may preferably be a polyvalent carboxylic ester plasticizer. Particularly preferred is an aromatic polyvalent carboxylic ester plasticizer. Such a polyvalent carboxylic acid may preferably have a benzene ring therein such as terephthalic acid, isophthalic acid, or trimellitic acid. An alcohol to be reacted with the polyvalent carboxylic acid may be methanol, ethanol, butanol, pentanol, hexanol, octanol, ethyl hexanol, caprylic alcohol, nonanol, isononyl alcohol, decanol, isodecyl alcohol, undecyl alcohol, lauryl alcohol, tridecyl alcohol, benzyl alcohol, or cyclohexanol. More preferably, the plasticizer may be a phthalic acid series plasticizer such as DOP (di-2-ethyl hexyl phthalate), DBP (dibutyl phthalate), BBP (butyl benzyl phthalate) or the like; or a trimellitic ester series plasticizer such as TBTM (tributyl.trimllitate), TOTM (tri.2-ethyl hexyl.trimellitate) or the like.

According to the polymer composition of the present invention, protectants known in radiation resistant polymer specifications may be used. Such protectants includes electron ion capturing agents, energy transfer agents, antioxidants, radical capturing agents, and radical inactivating agents.

The electron ion capturing agents include pyrene, quinone, diphenylenediamine, tetramethyl phenylenediamine, or the like. The energy transferring agents include acenaphthene, acenaphthylene, etc. The radical capturing agents include mercaptan, phenyl ether, and hydrophenanthrene. The antioxidants include various kinds of phenols and an organic thioate.

Various kinds of compounding agents and additives may be added to a polymer composition according to the present invention. Specifically listed are various kinds of cross-linking agents required for cross-linking, a cross-linking accelerator, stearic acid, a cross-linking aid such as zinc oxide, an age resistor of phenolic series, amine series, and quinone series, an ultraviolet absorbent such as benzophenone, hindered amine benzotriazole, and salicylic acid derivative, a filler such as calcium carbonate, clay, magnesium carbonate, or the like, a reinforcing agent such as carbon black, silica, and surface treated calcium carbonate, other processing aids, a foaming agent, a flame retarder, a colorant, a tackifier, and so on. Although sulfur is used as a cross linking agent in many rubber compositions, other metal oxides and organic peroxides may be used in a composition according to the present invention.

### EXAMPLES

The present invention will be described further in detail referring to the following inventive and comparative examples.

Each of the blending compositions shown in Table 1 was kneaded with a pressure kneader having a volume of 1 liter at 100° C. for 20 minutes to obtain a kneaded blend, which was then rolled by a 6-inch open roller to obtain a sheet-shaped sample having a length of 2 mm. The sample was then vulcanized and shaped by a press at 170° C. for 20 minutes. Samples 1 to 4 shown in Table 1 were according to the present invention and Samples 5 to 7 were not according to the present invention. Further, each blend shown in Table 1 was shown as a reference numeral in parenthesis. The reference numeral in each parenthesis corresponds to each reference numeral shown in Table 2.

TABLE 1

| Composition | 1 | 2 | 3 | 4 | 5 | 6 | 7 |
|---|---|---|---|---|---|---|---|
| EPDM (1) | 80 | 10 | 60 | 93 | 98 | 0 | 25 |
| CSM (2) | 5 | 0 | 0 | 0 | 0 | 65 | 0 |
| B-10 (3) | 0 | 50 | 0 | 0 | 0 | 0 | 0 |
| Second polymer | 85 | 60 | 60 | 93 | 98 | 65 | 25 |
| Component | | | | | | | |
| IIR (4) | 15 | 40 | 40 | 7 | 2 | 35 | 75 |
| IBR (5) | 0 | 5 | 0 | 0 | 0 | 0 | 0 |
| First polymer | 15 | 45 | 40 | 7 | 2 | 35 | 75 |
| Component | | | | | | | |
| Softening | 15 | 30 | 0 | 28 | 20 | 1 | 10 |
| Agent(6) | | | | | | | |
| Plasticizer (7) | 0 | 10 | 30 | 0 | 20 | 0 | 40 |
| Total content | 15 | 40 | 30 | 28 | 40 | 1 | 50 |
| Of(6) and (7) | | | | | | | |
| Carbon□□□ | 35 | 50 | 0 | 55 | 50 | 45 | 0 |
| Silica (9) | 5 | 0 | 50 | 20 | 0 | 10 | 30 |
| Clay (10) | 0 | 20 | 50 | 0 | 0 | 10 | 50 |
| Additives | 9 | 9 | 8 | 15 | 8 | 7 | 6.5 |
| (11)˜(14) | | | | | | | |
| Stearic acid(15) | 1 | 1 | 1 | 1 | 1 | 1 | 1 |
| Zinc white (16) | 5 | 5 | 5 | 5 | 5 | 5 | 5 |
| MgO(17) | 0.5 | 3 | 1.5 | 0 | 0 | 3.5 | 0 |
| Sulfur (18) | 1.5 | 0.5 | 1 | 2 | 1.5 | 0.6 | 1.5 |
| Accelerator | 4.3 | 2 | 4.8 | 4.6 | 3.7 | 3.2 | 4.5 |
| (19)˜(22) | | | | | | | |

| < | > | |
|---|---|---|
| * (1) | EPDM # 4045 | MitsuiChemicals, Inc. |
| * (2) | Hypalon # 40 | SHOWA DENKO K.K. |
| * (3) | B-10 | TOSOH CORPORATION |
| * (4) | IR # 268 | JSR |
| * (5) | Vistanex L-140 | Exxon |
| * (6) | AH-16 | Idem itsu sekiyu |
| * (7) | DOP | DaihachiChemicalIndustry Co., Ltd. |
| * (8) | Asahi # 60 | AsahiCarbon |
| * (9) | Nipp Seal AQ | Japan silica industry |
| * (10) | Dixie Clay | Vander Bilt |
| * (11) | Bio Soap 100 | KYODO CHEMIAL CO., LTD. |
| * (12) | Adecus tab LA-32 | AsahiDenka Co., Ltd. |
| * (13) | Noklak CD | OUCHISHNKO CHEMICAL INDUSTRIAL CO., LTD. |
| * (14) | Noklak 8C | OUCHISHNKO CHEMICAL INDUSTRIAL CO., LTD. |
| * (15) | Lunak S-20 | Kao corporation |
| * (16) | zinc white 3$$ | Shodo chemical |
| * (17) | Magnesium oxide # 150 | Kyowa Chemical |
| * (18) | Sulfax PS | TsurumiChemicalIndustry |
| * (19) | Noksellar M | OUCHISHNKO CHEMICAL INDUSTRIAL CO., LTD. |
| * (20) | Noksellar TT | OUCHISHNKO CHEMICAL INDUSTRIAL CO., LTD. |
| * (21) | Noksellar BZ | OUCHISHNKO CHEMICAL INDUSTRIAL CO., LTD. |
| * (22) | Accel 22-S | KawaguchiChemial |

As shown in Table 1, “EPDM” represents a terpolymer of ethylene, propylene, and diene, “CSM” represents chlorosulfonated polyethylene, and “B-10” represents chloroprene rubber. These three components belong to the second polymer component. “IIR” represents butyl rubber, and “IBR” represents polyisobutylene rubber. The aniline point of softening agent (6) is 20. 5° C. and the plasticizer is DOP. Doses of 3 MGy, 7MGy, and 10 MGy was radiated to each sample of the blending examples. Hs (surface hardness) was measured according to JIS K 6263 and TSB (breaking strength) and ELB (breaking elongation) were measured according to JIS 6251, before and after the irradiation. The results are shown in Table 3.

TABLE 3

| | | Blending examples | | | | | | |
|---|---|---|---|---|---|---|---|---|
| | | 1 | 2 | 3 | 4 | 5 | 6 | 7 |
| Blank | Hs | 51 | 50 | 55 | 63 | 46 | 69 | 49 |
| | TSB | 13 | 17.9 | 14.8 | 17.4 | 14.7 | 18.8 | 16.2 |
| | ELB | 700 | 610 | 720 | 690 | 820 | 640 | 760 |
| 3 | Hs | 56 | 55 | 57 | 71 | 70 | 79 | 50 |
| MGy | TSB | 97 | 12.5 | 11.9 | 15.9 | 7.7 | 7.1 | 6.5 |
| | ELB | 510 | 570 | 600 | 450 | 130 | 190 | 500 |
| 7 | Hs | 68 | 51 | 53 | 77 | 85 | 88 | 44 |
| MGy | TSB | 7.2 | 8.4 | 9.1 | 20.2 | 6.2 | 6.6 | 6.2 |
| | ELB | 220 | 260 | 270 | 170 | 70 | 80 | 810 |
| 10 | Hs | 73 | 44 | 49 | 81 | 88 | 91 | 32 |
| MGy | TSB | 6.8 | 7.3 | 8.3 | 25.8 | 5.5 | 5.9 | 4.7 |
| | ELB | 120 | 200 | 190 | 140 | 50 | 40 | 990 |

| | | | | | | | |
|---|---|---|---|---|---|---|---|
| Judgement of | Good | Good | Good | Good | Deterio- | Deterio- | Deterio- |
| Results about | | | | | ration | Ration | Ration |
| Radiation | | | | | Due to | Due to | Due to |
| Resistance | | | | | Hardening | Hardening | Softening |

According to blending example 1, 85 weight parts of the second polymer component and 15 weight parts of the first polymer component were mixed to obtain a mixture, to which 15 weight parts of softening agent (6) was added. As a result, even after the sample was exposed to a radiation dose of 10 MGy, the increase in the surface hardness and the reduction of breaking strength and elongation were proved to be small.

According to blending example 2, 60 weight parts of the second polymer component and 45 weight parts of the first polymer component were mixed to obtain a mixture, to which 40 weight parts of softening agent (6) and plasticizer (7) were added. As a result, even after the sample is exposed to a radiation dose of 10 MGy, the increase in surface hardness and the reduction of breaking strength and elongation were small.

According to blending example 3, 60 weight parts of the second polymer component and 40 weight parts of the first polymer component were mixed to obtain a mixture, to which 30 weight parts of softening agent (6) and plasticizer (7) were added. As a result, even after the sample is exposed to a radiation dose of 10 MGy, the increase in surface hardness and the reduction of breaking strength and elongation were small.

According to blending example 4, 93 weight parts of the second polymer component and 7 weight parts of the first polymer component were mixed to obtain a mixture, to which 28 weight parts of softening agent (6) and plasticizer (7) were added. As a result, even after the sample is exposed to a radiation of a dose of 10 MGy, the increase in surface hardness and the reduction of breaking strength and elongation were small.

According to blending example 5, 98 weight parts of the second polymer component and 2 weight parts of the first polymer component were mixed to obtain a mixture, to which 40 weight parts of a softening agent and plasticizer were added. As a result, after the sample is exposed to a radiation dose of 10 MGy, the increase in surface hardness and the reduction of breaking elongation were proved to be considerable.

According to blending example 6, 65 weight parts of the second polymer component and 35 weight parts of the first polymer component were mixed to obtain a mixture, to which 1 weight part of a softening agent and plasticizer were added. As a result, after the sample is exposed to a radiation dose of 10 MGy, the rise of the surface hardness and the reduction of the breaking strength and elongation were proved to be considerable.

According to blending example 7, 25 weight parts of the second polymer component and 75 weight parts of the first polymer component were mixed to obtain a mixture, to which 50 weight parts of a softening agent and plasticizer were added. As a result, after the sample is exposed to a radiation dose of 10 MGy, the surface hardness was lowered, and the reduction of the breaking strength was considerable and the breaking elongation was slightly elevated.

As described above, it is proved that the deterioration of the surface hardness, breaking strength, and breaking elongation of a composition can be prevented, even after the composition is exposed to a high level dose of radiation within a composition range according to the present invention.

The present invention provides a composition exhibiting high level of physical properties as shown in the above examples even after the composition is exposed to a high level dose of radiation, which is the first case in the world.

The present invention has been explained referring to the preferred embodiments, however, the present invention is not limited to the illustrated embodiments which are given by way of examples only, and may be carried out in various modes without departing from the scope of the invention.

What is claimed:

1. A method of putting a radiation resistant cross linked polymer composition in an environment in which a radiation is exposed,
said composition comprising polymer components and a softening agent in an amount of 3 weight parts or more with respect to 100 weight parts of said polymer components, said polymer components comprising a first polymer component of one or more polymer selected from the group consisting of butyl rubber, polyisobutylene rubber, epichlorohydrin rubber and polypropylene in a content of 3 to 70 weight parts and a second polymer component of one or more polymer selected from the group consisting of chloroprene rubber and a polymer containing an ethylene unit as a main component in a content of 97 to 30 weight parts,
wherein:
the softening agent has an aniline point of 60° C. or lower; and
the softening agent comprises a plasticizer of an aromatic carboxylic ester.

2. The method of claim 1, wherein said polymer containing an ethylene unit comprises one or more component selected from the group consisting of ethylene-propylene rubber, chlorosulfonated polyethylene rubber, polyethylene and chlorinated polyethylene rubber.

3. The method of claim 1, wherein the softening agent has an aniline point of 45° C. or lower.

4. The method of claim 1, further comprising a plasticizer of a polyvalent carboxylic ester.

5. The method of claim 4, wherein the polyvalent carboxylic ester comprises an aromatic polyvalent carboxylic ester.

6. The method of claim 1, wherein the radiation resistant cross linked polymer composition is exposed to a dose of radiation of 3 Mgy or more.

7. A method of putting a radiation resistant product in an environment in which a radiation is exposed, said product comprising a cross linked polymer composition,
said composition comprising polymer components and a softening agent in an amount of 3 weight parts or more with respect to 100 weight parts of said polymer components, said polymer components comprising a first polymer component of one or more polymer selected from the group consisting of butyl rubber, polyisobutylene rubber, epichlorohydrin rubber and polypropylene in a content of 3 to 70 weight parts and a second polymer component of one or more polymer selected from the group consisting of chloroprene rubber and a polymer containing an ethylene unit as a main component in a content of 97 to 30 weight parts,
wherein:
the softening agent has an aniline point of 60° C. or lower; and
the softening agent comprises a plasticizer of an aromatic carboxylic ester; and
the product is selected from the group consisting of a distribution line, a power cable, a sheath, a water cut-off material and a packing.

8. The method of claim 7, wherein the radiation resistant cross linked polymer composition is exposed to a dose of radiation of 3 Mgy or more.
